(19) United States
(12) Patent Application Publication
(10) Pub. No.: US 2003/0120989 A1
(43) Pub. Date: Jun. 26, 2003

(54) Method and circuit to implement double data rate testing

(76) Inventor: John F. Zumkehr, Orange, CA (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/025,760

(22) Filed: Dec. 26, 2001

(51) Int. Cl. G06F 11/00

(52) U.S. Cl. 714/738

(57) ABSTRACT

A DDR apparatus is provided that includes a pattern generating device to generate a clock test pattern and a data test pattern and buffer devices to receive the clock test pattern and the data test pattern. A pattern checking device checks patterns received from the buffer devices. Clock generating logic controls a clock for the clock test pattern and a clock for the data test pattern.

### FIELD

The present invention is directed to the field of integrated circuits. More particularly, the present invention is directed to testing of integrated circuits.

### BACKGROUND

As integrated circuit features continue to shrink, test costs relentlessly rocket skyward. Greater numbers of interface nodes, higher operating frequencies, and specialized packaging arrangements such as multi-chip modules all contribute to soaring test costs.

To avoid wasting packaging materials and assembly costs, some tests may be performed on an integrated circuit die prior to assembly. Equipment for testing integrated circuits before assembly may increase the cost and complexity as die contacts decrease in size and increase in number. Indeed, the cost of exhaustive pre-assembly testing of every interface node of an integrated circuit is becoming prohibitive. Unfortunately, saving costs by reducing pre-assembly testing may translate into increasing post-assembly waste.

Output buffers and input/output (I/O) buffers are features of an integrated circuit that typically must be thoroughly tested prior to sale. These buffers are ordinarily tested by test equipment that skews the relative relation between data signals and a clock or strobe signal until a failure is detected.

Source synchronous buffers are one type of buffer generally characterized in this manner. Source synchronous buffers may operate by transmitting the strobe along with data from a driving chip to a receiving chip. With careful control over the signal paths, the transfer rate of information can be maximized because the strobe edge can be accurately placed to minimize the skew relative to the data.

At the destination, the strobe signal may be used to create a window during which data should be captured. Manufacturing flaws or processing excursions adversely affecting the characteristics of the input or output circuitry may cause an input latch to fail to capture the data. For example, abnormal performance of a circuit that buffers the strobe signal may alter timing relationships sufficiently to cause failure under some operating conditions.

In order to detect such failures, source synchronous testing may use expensive test equipment to provide data to each pin and appropriate strobe input. This scheme may require that a tester channel be assigned, or at least a tester interface be coupled to each buffer that is to be tested. This type of testing can be performed either before or after assembly. Source synchronous buffer testing may also be done in systems after the integrated circuits are assembled. This system testing may also require that each buffer tested is coupled to another system component.

Thus, buffers may be characterized before packaging by using expensive test equipment that contacts an interface node for each buffer. If testing is only performed after packaging, packaging materials and assembly costs may be wasted on parts having failures that could have been detected earlier.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and that the invention is not limited thereto.

The following represents brief descriptions of the drawings in which like reference numerals represent like elements and wherein:

FIG. 1 is a block diagram of an example system;

FIG. 2 is a schematic representation of a buffer circuit;

FIG. 3 is a timing diagram of signals in a DDR device; and

FIG. 4 is a diagram of a clocking mechanism according to an example embodiment of the present invention.

### DETAILED DESCRIPTION

In the following detailed description, like reference numerals and characters may be used to designate identical, corresponding or similar components in differing figure drawings. Further, in the detailed description to follow, example values may be given, although the present invention is not limited to the same. Well-known power/ground connections may not be shown within the FIGS. for simplicity of illustration and discussion, and so as not to obscure the invention. Where specific details (e.g., circuits) are set forth in order to describe example embodiments of the invention, it should be apparent to one skilled in the art that the invention can be practiced without, or with variation of, these specific details. Finally, it should be apparent that differing combinations of hard-wired circuitry can be used to implement embodiments of the present invention. That is, the present invention is not limited to any specific combination of hardware.

Embodiments of the present invention may be described with respect to a signal(s) and/or a signal line. These terminologies are intended to be interchangeable between each other and between the singular and the plural. While signals (or values) may be described as HIGH or LOW, these descriptions of HIGH and LOW are intended to be relative to the discussed arrangement and/or embodiment. That is, a value may be described as HIGH in one arrangement although it may be LOW if provided in another arrangement. The terms HIGH and LOW may be used in an intended generic sense. Embodiments and arrangements may be implemented with a total/partial reversal of any of the HIGH and LOW signals by a change in logic.

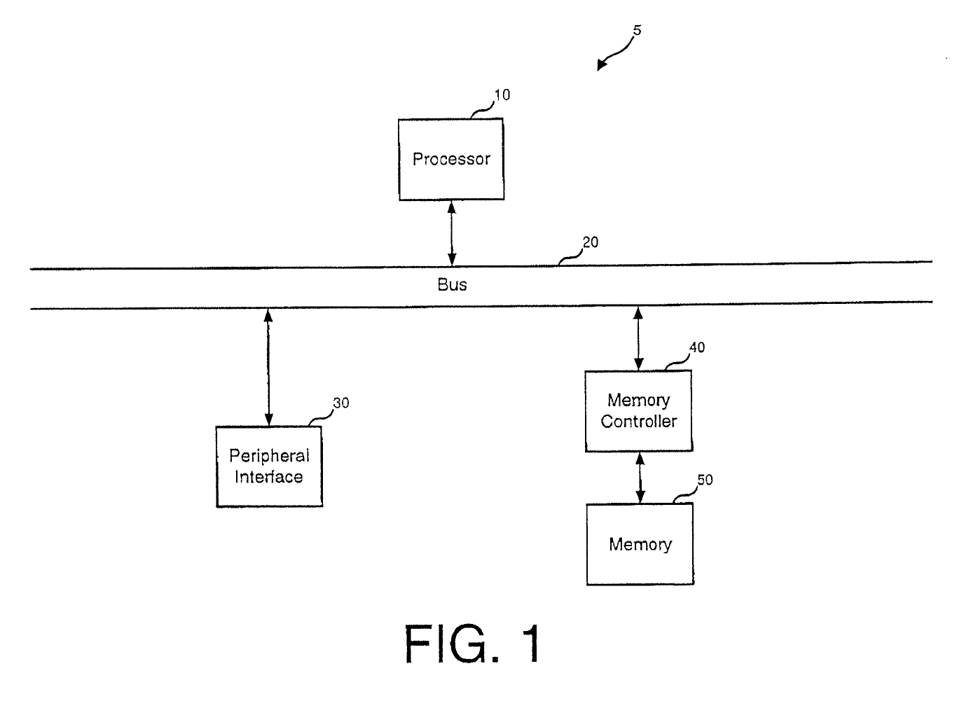

FIG. 1 illustrates an example system 5. As may be appreciated by one of ordinary skill in the art, numerous configurations of the system 5 are possible. The system 5 may include a processor 10 coupled to a bus that may include one or more buses and/or bridges. The system 5 may further include a peripheral interface 30 and a memory controller 40 coupled to the bus 20. The peripheral interface 30 and the memory controller 40 may receive and transmit data to and from the processor 10 via the bus 20. The system 5 may also include a memory 50 coupled to the memory controller 40. The memory controller 40 may enable the processor 10 and/or the peripheral interface 30 to access the memory 50.

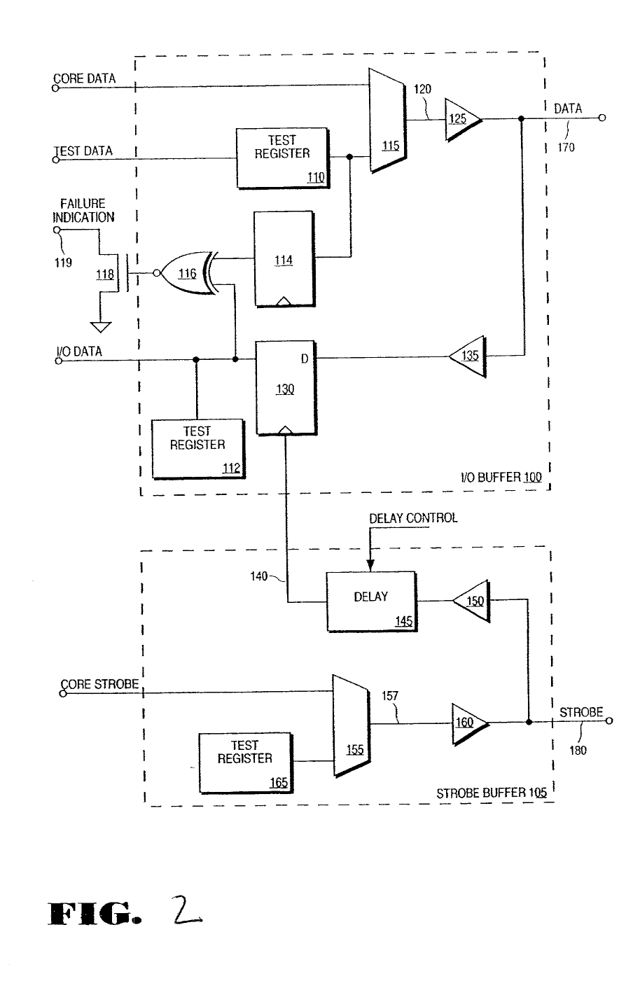

Embodiments of the present invention relate to testing of double date rate (DDR) devices. More specifically, the testing relates to AC I/O loopback testing. Prior to explaining AC I/O loopback testing, FIG. 2 will be briefly described so as to explain self-testing.

FIG. 2 illustrates a self-testing buffer according to one arrangement. Typically, a plurality of these buffers provide an I/O interface between one integrated circuit and a system. Each buffer may include an I/O buffer circuit 100 whereas a strobe buffer circuit 105 may be shared with a group of I/O buffer circuits. The I/O buffer circuit 100 and the strobe buffer circuit 105 may transfer data from the integrated circuit to the system via a first interface node 170 and a second interface node 180. In a test mode, the strobe buffer circuit 105 may provide the I/O buffer circuit 100 with a delayed strobe signal on a signal line 140, thereby allowing self-test and characterization.

The I/O buffer circuit 100 may drive the first interface node 170 according to a data input node 120 using an output buffer 125. A multiplexer 115 may select the data input node from a CORE DATA line and an output of a test register 110. The test register 110 is a data test register that receives data from a TEST DATA line and that can be a part of either a serial test chain or a parallel test register.

An input portion of the I/O buffer circuit 100 may receive a data value from the first interface node 170 and drive this data value to an input latch 130 using an input buffer 135. The input latch 130 may have a clock input coupled to the signal line 140 to receive the delayed strobe signal from the strobe buffer circuit 105. The input latch 130 may provide a sampled value at the input latch output. The sampled value may then be sent as I/O DATA to the core and to a second test register 112. This second test register 112 may be particularly useful in isolating which I/O buffer fails and may be part of either a serial test chain or a parallel test register.

When it is necessary to detect that a failure exists but not which specific circuit fails, a failure indication signal may be examined to determine the test status of a plurality of buffers. This failure indication signal may be asserted on a failure indication line 119 by feedback comparison circuitry that compares an expected value to the sampled value for each buffer. In the illustrated arrangement, the feedback comparison circuitry may include an exclusive NOR gate 116 that compares the value from a test feedback latch 114 to the sampled value provided by the input latch 130. Alternate arrangements may employ only one of the failure indication line and the test register 112 to detect incorrect values.

A failure indicated on the failure indication line may be due to a faulty strobe buffer circuit. When properly functioning, the strobe buffer circuit 105 may drive a strobe signal on the second interface node 180 using an output buffer 160. A strobe input node 157 may be selected by a multiplexer 155 from a CORE STROBE line and a third test register 165 may provide an input signal to the second output buffer 160. An input buffer 150 may couple the strobe signal to an input of an adjustable delay circuit 145. The adjustable delay circuit 145 may receive a delay control signal on a delay adjust input and accordingly provide the delayed strobe signal on the signal line 140 to the clock input of the input latch 130. The delay control signal may be directly coupled from an interface of the integrated circuit or may be coupled to test control logic.

In a non-test mode, the I/O buffer circuit 100 may drive the first interface node 170 and the second interface node 180 approximately simultaneously. This may be accomplished by properly controlling the timing of the core data and the core strobe signals. In an alternate arrangement, a clocked output circuit effectuates the dispatch of core DATA and STROBE signals. In either case, DATA and STROBE are provided at the interface nodes substantially simultaneously. DATA and STROBE signals are carefully routed to their destinations to maintain these timing relationships.

In a test mode, the STROBE and DATA signals are again driven to the interface nodes substantially simultaneously; however, in this case, the signals originate from the test registers 110 and 165. The strobe signal propagates through the adjustable delay circuit and clocks the input latch. This strobe signal creates a window in which data can be captured by the input latch. If the data from the test register 110 is not driven to the interface node 170 and is captured by the input latch 130 during this window, the sampled value at the input latch output will not properly reflect the data value driven by the output buffer 125. The delay control signal may be used to adjust the window in which data is captured by the input latch, thereby allowing characterization of the I/O buffer circuit 100. By analyzing the contents of the test registers such as the test register 112, an I/O buffer circuit 100 exhibiting unacceptable performance may be detected.

A brief discussion of Double Data Rate (DDR) devices will now be provided.

One method to improve the transfer rate of memory may utilize DDR devices to transfer data at both a leading edge of a clock cycle and a trailing edge of the clock cycle. DDR devices may have a source-synchronous clocking protocol to transfer data from the memory to a memory controller.

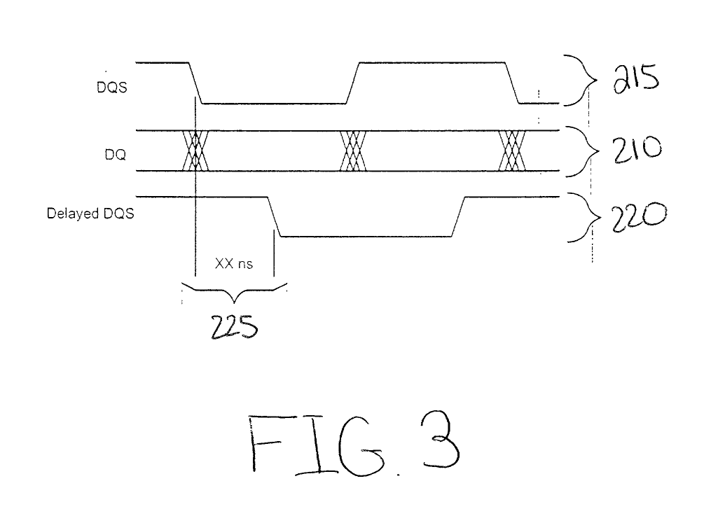

FIG. 3 is a timing diagram of the signals in a DDR device. Data (DQ) 210 from memory may be captured by the memory controller using a clock or strobe signal (DQS) 215 supplied by the memory devices. However, in order to avoid data errors that may occur when the strobe (DQS) signal levels change, each strobe (DQS) signal 215 from memory may be delayed 225 as shown in the delayed DQS signal 220 so that data may be clocked in the center of the valid data window. That is, the DQS signal from the memory devices may be delayed by the memory controller to capture the data from the memory devices. The precision of the strobe delay 225 may be important because any variation in the strobe delay may translate into added setup/hold time for the memory controller. Uncertainty in this DQS delay and setup and hold for the capture mechanism may add to the overall setup and hold time for the memory controller. If the setup/hold time is too large, the system may become unworkable. This may be especially true as DDR technology moves to faster speeds.

The setup and hold relationship between the data (DQ) 210 and the clock signal (DQS) 215 at the memory controller may become smaller and smaller as DDR memory gets faster. This presents a problem for testing. External testers may have limitations on maintaining a tight timing relationships between multiple tester pins due to tester edge placement limitations. These limitations may require the tested setup and hold time to be relaxed to guarantee that tested parts meet published specifications. This may double the setup and hold times of the memory controller, which reduces the system margins. As memory speeds further increase, the performance of the system cannot be guaranteed.

One solution for chipsets and other interfaces is to incorporate a self-test function on the die that does not depend on an external tester's accuracy to measure setup and hold times. This method is called AC Input/Output (I/O) loopback testing. In AC I/O loopback testing, a test pattern may be generated on-die. The test pattern is looped through bidirectional output buffers, received and then compared with the original test pattern. The receive register may be clocked with a delayed source-synchronous clock that is programmed with the desired setup and hold parameters for the inputs. Because the pattern is generated on-die, the accuracy of the test pattern may be only related to the skew due to clock error for the source synchronous test pattern, which can be about 25% or less than that of current testers.

Implementing AC I/O loop-back testing may be difficult for DDR I/O in that part of the setup and hold on the memory controller is the uncertainty of a delay line used to delay the clock signal (DQS) that captures the data (DQ). This same delay line that is a large part of the setup/hold measurement must be counted on to test itself. This may make the value of this test degrade because the uncertainty of the delay line may be used to provide accurate testing. This may be larger than the tester edge placement limitations.

Integrating AC I/O loop-back testing into DDR type I/Os may present a problem due to the coincidental nature of the DQ and DQS signals. It is desirable to integrate this technique with DDR I/O to reduce the setup and hold times.

Embodiments of the present invention may provide a circuit that includes a pattern generating device to generate a clock test pattern and a data test pattern for at least one DDR I/O cell, a pattern checking device to check patterns passing through the DE)R I/O cell and clock generating logic to control a clock for the clock test pattern and the clock for a data test pattern. The clock generating logic may include at least one switching element (such as a mulitplexer) to switch among a plurality of modes (such as a normal mode and a test mode). The clock generating logic may also include a delay element.

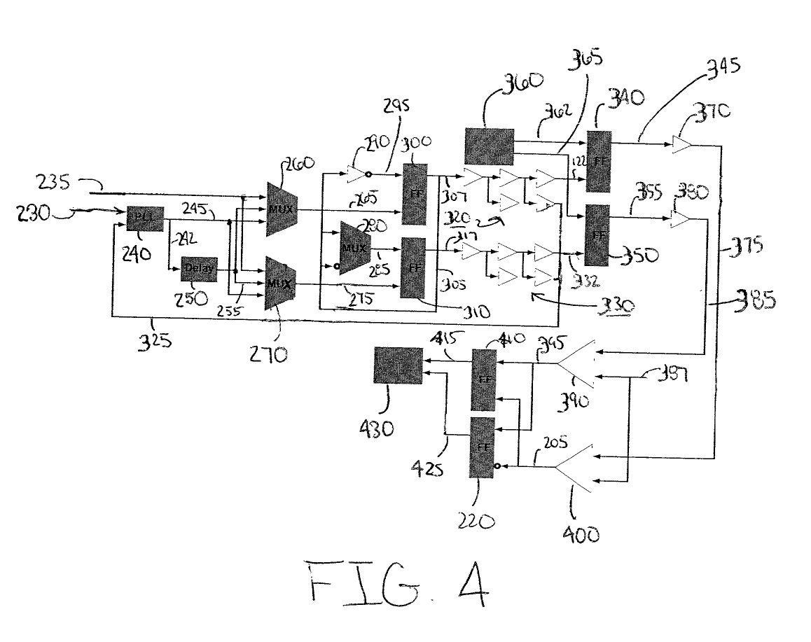

FIG. 4 is a diagram of a clocking mechanism according to an example embodiment of the present invention. Other embodiments and configurations are also within the scope of the present invention. More specifically, FIG. 4 illustrates a clocking mechanism for DDR self-testing using AC I/O loopback testing. As shown in FIG. 4, a clock (such as a front side bus clock) may be provided on a signal line 230 to a phase lock loop (PLL) device 240. The phase lock loop device 240 may output a signal along a signal line 245 to one input of a multiplexer 260. The phase lock loop device 240 may also provide the signal along the signal line 245 to one input of a multiplexer 270. The phase lock loop device 240 may also provide a signal along a signal line 242 to a delay circuit 250. The delay circuit 250 may provide a delayed signal along a signal line 255 to one input of a multiplexer 260 and/or to one input of a multiplexer 270. A bypass test clock signal 235 may also be provided along a signal line 235 to one input of the multiplexer 260 and/or to one input of the multiplexer 270. As will be described below, a select signal input to the multiplexer 260 and input to the multiplexer 270 may be used to select the output of the multiplexer 260 on a signal line 265 and to select the output of the multiplexer 270 on a signal line 275.

The output signal on the signal line 265 may be provided to a clock input of a flip-flop circuit 300 and the output signal on the signal line 275 may be provided to a clock input of the flip-flop circuit 310. Outputs of the flip-flop circuit 300 and/or the flip-flop circuit 310 may be provided along a signal line 305 to an inverter circuit 290 that provides a signal along a signal line 295 to an input of the flip-flop circuit 300. The signal along the signal line 305 may also be provided to one input of a multiplexer 280. The other input of the multiplexer 280 may be provided along the signal line 305 as an inverted circuit signal. The multiplexer 280 may output a signal along a signal line 285 based on a select signal input to the multiplexer 280 (not directly shown in FIG. 4).

The flip-flop circuit 300 provides an output signal along a signal line 307 based on the clock signal input to the flip-flop circuit 300 on the signal line 265. The signal on the signal line 307 may be provided to a clock tree 320 that, as shown in FIG. 4, may include a plurality of cascaded buffers. Similarly, the output of the flip-flop circuit 310 is provided along a signal line 317 based on the clock signal input to the flip-flop circuit 300 on the signal line 275. The signal on the signal line 317 may be provided to a clock tree 330 that, as shown in FIG. 4, may include a plurality of cascaded buffers. The clock tree 320 provides an output signal along a signal line 322 to a clock input of a flip-flop circuit 340. Another output of the clock tree 320 may be provided along a signal line 325 to one input of the phase lock loop device 240 as a feedback signal. Similarly, the clock tree 330 provides an output signal along a signal line 332 to a clock input of a flip-flop circuit 350. Another output of the clock tree 330 may be provided along a signal line 325 to an input of the phase lock loop device 240 as a feedback signal.

Each of the flip-flop circuits 340 and 350 may be used in a self-test mode to appropriately generate a pattern and test the pattern in a manner similar to AC I/O loopback testing. More specifically, a pattern generating device 360 may provide a signal pattern along a signal line 162 to the flip-flop circuit 340. The flip-flop circuit 340 may provide an output signal (such as a DQS test pattern) along a signal line 345 based on the clock signal (i.e., a clock for the DQS test pattern) input to the flip-flop circuit 340 on the signal line 322. As discussed above, the clock signal may be generated by the clock tree 320. Similarly, the flip-flop circuit 350 may provide an output signal (such as a DQ test pattern) along a signal line 355 based on the clock signal (i.e., a clock for the DQ test pattern) input to the flip-flop circuit 350 on the signal line 332. The clock signal may be generated by the clock tree 330. Accordingly, the pattern generating device 360 operates in conjunction with the flip-flop circuit 340 based on clock inputs along the signal line 322 to appropriately create DQS test patterns along the signal line 345. The pattern generating device 360 also operates in conjunction with the flip-flop circuit 350 based on clock inputs along the signal line 332 to appropriately create DQ test patterns along the signal line 355.

The DQS test pattern may be provided to a DDR I/O cell 370, which is the device or component being tested. Similarly, the DQ test pattern may be provided along the signal line 355 to a DDR I/O cell 380, which is another device or component being tested. The pattern output from the DDR I/O cell 370 may be provided along a signal line 375 to one input of an amplifier circuit 400. Similarly, the pattern signal output from the DDR I/O cell 380 may be provided along a signal line 385 to one input of an amplifier circuit 390. A VREF signal may be provided along a signal line 387 to one input of the amplifier circuit 390 and to one input of the amplifier circuit 400. The amplifier circuits 390 and 400 may correspond to a receiving device in the integrated circuit. Based on its inputs, the amplifier circuit 390 may provide an output signal along a signal line 395 to a flip-flop circuit 410 and to a flip-flop circuit 420. Similarly, the amplifier circuit 400 may provide an output signal along the signal line 405 to the flip-flop circuit 410 and to the flip-flop circuit 420. The flip-flop circuit 410 may provide an output signal along a signal line 415 to a pattern checking device 430 and the flip-flop circuit 420 may provide an output signal along a signal line 425 to the pattern checking device 430. The pattern checking device 430 may appropriately check the received pattern and compare the received pattern based on the pattern that was generated by the pattern generating device 360.

Embodiments of the present invention may include logic (such as state logic) that controls each of the multiplexers 260, 270 and 280 as well as other components. The logic may select an appropriate mode for the clocking circuitry such as a normal mode, a hold mode, and a set-up testing mode. The selection of the mode may be used to select the appropriate output from each of the multiplexers 260, 270 and 280. This selection appropriately changes the clock signal that is provided along the signal line 322 (from the clock tree 320) to the flip-flop circuit 340 and changes the clock signal that is applied along the signal line 332 (from the clock tree 330) to the flip-flop circuit 350. More specifically, in a normal mode, a quarter cycle of delay may be provided between the clock signal and the data signal. However, in a test mode, the quarter of a cycle of delay is not used and the clock signal and data signal are in phase with one another. That is, it is desirable to utilize the same clock edge for both clock trees. As discussed above, the delay element 250 provides a small delay of the clock on the signal line 230. The delay device 250 may be used in conjunction with the selected inputs from each of the multiplexers 260, 270 and 280 to appropriately provide the proper clock signals to the flip-flop circuits 340 and 350.

The memory controller may have two clock trees (such as the clock tree 320 and the clock tree 330) to implement the required timing for writes to the DDR type memory. One of the clock trees may run at twice the DDR memory clock rate while the other clock tree may be equivalent to the first clock tree except that it is 180 degrees out of phase. This may be called a clock/clock bar implementation. However, when generating AC I/O loopback patterns, the two clock trees may be in phase for the normal read test case. To handle this, the clock generation logic may operate as two clock trees and two modes, namely an in-phase mode and an out-of-phase mode. In the test mode, when the clock trees are generated in phase, modification may be used to test both the set-up and hold times. A delay element (shown as the delay device 250) may be calibrated for the set-up/hold test value that may be inserted into the appropriate clock tree generation logic to perform the set-up/hold testing. This delay element may have been calibrated before the testing phase.

As shown, pattern generation logic (shown as the pattern generating device 160) may be coupled to the DQ/DQS output logic of the memory controller so that the appropriate test patterns may be outputted. On the receiver side of the DDR I/O cell (such as the DIDR I/O cells 170 and 180), a pattern checker (shown as the pattern checking device 430) may be coupled to verify proper data capture. If the received pattern does not match the expected pattern, then an error may be indicated in the test.

Accordingly, embodiments of the present invention may provide a system of logic to test the set-up and hold of DDR capture logic. This may include a state machine for performing pattern testing, logic for sending the looping patterns through the DDR devices for testing, and logic for control of the clock tree for testing and pattern detection and comparison logic. Logic to control the clock tree may include a clock and clock bar tree (such as the clock tree 320 and the clock tree 330), logic to select the source for the clock for set-up and hold testing (such as the state logic that is applied to each of the multiplexers 260, 270 and 280) as well as a delay cell (shown as the delay element 250) for set-up and hold testing.

Embodiments of the present invention allow the AC I/O loopback to be incorporated into the memory controller. The pattern generation and checking logic may be included in an AC I/O loopback tester. Accordingly, embodiments of the invention may include a DDR apparatus that includes a pattern generating device to generate a clock test pattern and a data test pattern and buffer devices to receive the clock test pattern and the data test pattern. A pattern checking device may check patterns received from the buffer devices. Clock generating logic may control a clock for the clock test pattern and a clock for the data test pattern.

Any reference in this specification to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A DDR apparatus comprising:
a pattern generating device to generate a clock test pattern and a data test pattern; and
buffer devices to receive said clock test pattern and said data test pattern;
a pattern checking device to check patterns received from said buffer devices; and
clock generating logic to control a clock for said clock test pattern and a clock for said data test pattern.

2. The DDR apparatus of claim 1, wherein said clock generating logic operates such that in a test mode the clock for the clock test pattern is in phase with said clock for said data test pattern.

3. The DDR apparatus of claim 2, wherein said test mode comprises an AC I/O loopback test.

4. The DDR apparatus of claim 1, wherein said clock generating logic operates such that in a normal mode, said clock for said clock test pattern is out-of-phase with said clock for said data test pattern.

5. The DDR apparatus of claim 1, wherein said buffer devices are provided within a memory controller.

6. The DDR apparatus of claim 1, wherein said clock generating logic includes a delay element.

7. The DDR apparatus of claim 1, wherein said clock generating logic includes at least one switching element to switch among a plurality of different modes.

8. The DDR apparatus of claim 7, wherein said clock generating logic further includes state logic to control signals applied to said at least one switching element.

9. A circuit comprising:
a pattern generating device to generate a clock test pattern and a data test pattern for at least one DDR I/O cell;
a pattern checking device to check patterns passing through said at least one DDR I/O cell; and
clock generating logic to control a clock for said clock test pattern and a clock for said data test pattern.

10. The circuit of claim 9, wherein said clock generating logic operates such that in a test mode the clock for the clock test pattern is in phase with said clock for said data test pattern.

11. The circuit of claim 9, wherein said test mode comprises an AC I/O loopback test mode.

12. The circuit of claim 9, wherein said clock generating logic operates such that in a normal mode, said clock for said clock test pattern is out-of-phase with said clock for said data test pattern.

13. The circuit of claim 9, wherein said at least one DDR I/O cells is provided within a memory controller.

14. The circuit of claim 9, wherein said clock generating logic includes a delay element.

15. The circuit of claim 9, wherein said clock generating logic includes at least one switching element to switch among a plurality of different modes.

16. The circuit of claim 15, wherein said clock generating logic further includes state logic to control signals applied to said switching element.

17. A clock generating circuit to generate a first clock signal and a second clock signal for a DDR device, wherein said clock generating circuit generates said first clock signal in phase with said second clock signal when in a test mode and generates said first clock signal out of phase with said second clock signal when in a normal mode.

18. The clock generating circuit of claim 17, wherein said test mode comprises an AC I/O loopback test.

19. The clock generating circuit of claim 17, wherein said DDR device is provided within a memory controller.

20. The clock generating circuit of claim 17, wherein said clock generating logic includes a delay element.

21. The clock generating circuit of claim 17, wherein said clock generating logic includes at least one switching element to switch between at least said test mode and said normal mode.

22. The clock generating circuit of claim 23, wherein said clock generation logic further includes state logic to control signals applied to said switching element.

23. A method comprising:
generating a clock test pattern and a data test pattern;
passing said clock test pattern and said data test pattern through at least one DDR device;
checking patterns passing through said at least one DDR device; and
adjusting one of a clock for said clock test pattern and a clock for said data test pattern.

24. The method of claim 23, wherein said adjusting comprises providing said clock for said clock test pattern in phase with said clock for said data test pattern in a test mode.

25. The method of claim 24, wherein said test mode comprises an AC I/O loopback test.

26. The method of claim 23, wherein said adjusting comprises providing said clock for said clock test pattern out-of-phase with said clock for said data test pattern in a normal mode.

27. The method of claim 23, wherein said adjusting comprises using at least one switching element to switch among a plurality of modes.

28. The method of claim 27, wherein said adjusting further comprises switching in a delay element based on one of said plurality of modes.
